(19) United States
(12) Patent Application Publication
(10) Pub. No.: US 2015/0260092 A1
(43) Pub. Date: Sep. 17, 2015

(54) Rotary internal combustion engine with two opposite turbines

(71) Applicant: Julius Epman, Kelowna (CA)

(72) Inventor: Julius Epman, Kelowna (CA)

(21) Appl. No.: 14/214,696

(22) Filed: Mar. 15, 2014

(51) Int. Cl. F02B 55/14; F02B 55/02; F02B 53/12

(52) U.S. Cl. CPC F02B 55/14; F02B 53/12; F02B 55/02

(57) ABSTRACT

A four-cycle rotary internal combustion engine, comprised mainly of two turbines, each one consisting of a shaft with two blades, that interpenetrate, from the opposite directions of the same longitudinal axis, inside an enclosure with circular traversal section. Each turbine blade extends from its own shaft to the enclosure's walls and to the other turbine shaft, in order for all four blades to create four separate dynamic chambers inside the enclosure. Each chamber passes successively throughout all four strokes of the combustion cycle (intake, compression, power, and exhaust) during one turbine full revolution around said axis.

### CROSS-REFERENCE TO RELATED APPLICATIONS

Provisional patent application under 35 USC §119(e): Application Number 61803353.

### BACKGROUND OF THE INVENTION

Internal combustion engines with intermittent combustion using a four-stroke cycle, usually employ an eccentric rotary design (Wankel engine) or reciprocating pistons.

The present rotary engine with two opposite turbines has less moving parts than a reciprocating pistons engine as the valves and crankshaft are unnecessary. It also avoid the eccentric design and the moving combustion chamber specific to Wankel engine.

### BRIEF SUMMARY OF THE INVENTION

This invention provides a two opposite turbines based rotary engine of the type commonly called four-stroke internal combustion engine.

### BRIEF DESCRIPTION OF THE SEVERAL VIEWS OF THE DRAWING

FIG. 1. Longitudinal section of the engine.

FIG. 2. Turbine.

FIG. 3. Traversal section of the engine.

FIG. 4. Traversal diagram of the engine:

### DETAILED DESCRIPTION OF THE INVENTION

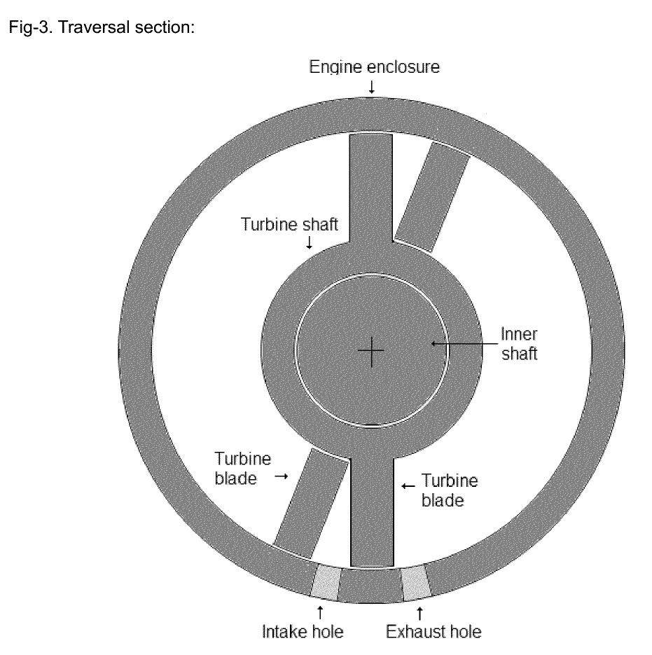

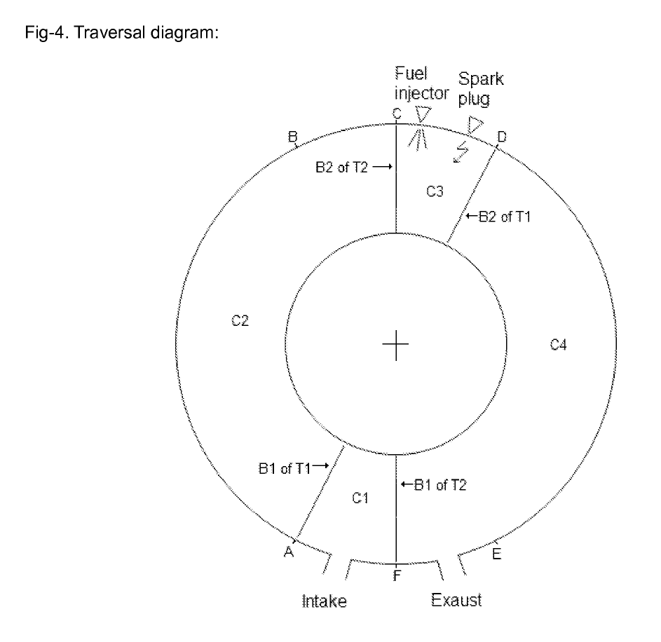

This invention represent a rotary four-stroke internal combustion engine, consisting of two turbines T1 and T2 (FIG. 4) that interpenetrate, from the opposite directions of the same axis, around a longitudinal inner shaft, inside an enclosure having circular traversal section (FIG. 3). The inner shaft and each turbine shaft have ends, extended outside the enclosure, so other rotary parts could be attached to them (for example flywheels), and useful mechanical output can be collected.

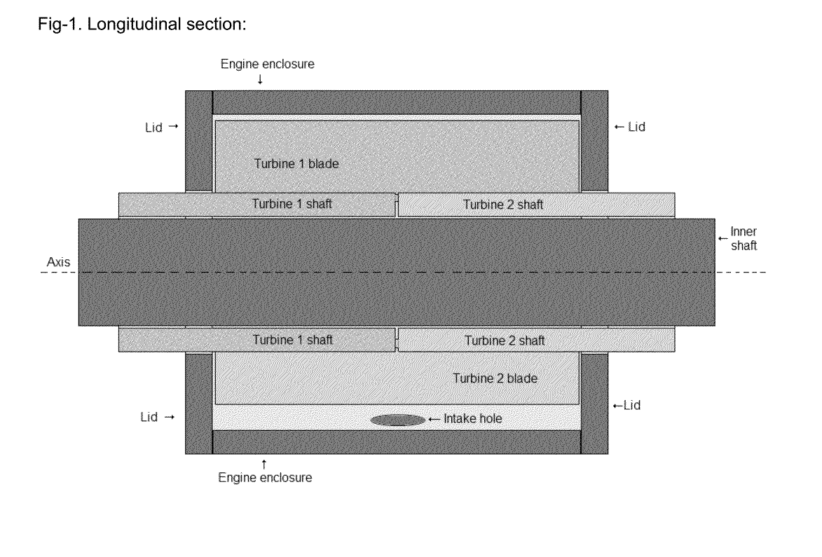

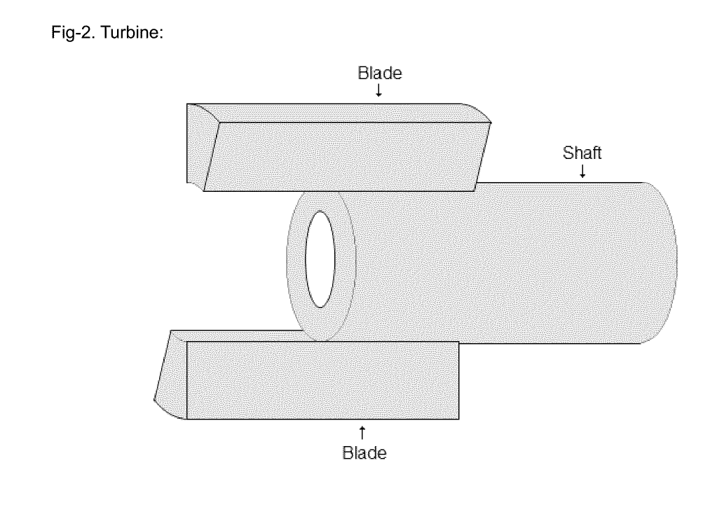

Each turbine consist in a shaft with two blades B1 and B2 (FIG. 4) attached at 180 degrees to each other. Any turbine blade extends from its own shaft to the enclosure's walls and to the other turbine shaft, in order for all four blades to create four separate dynamic chambers (C1 to C4 (FIG. 4)), inside the enclosure. The turbine blades could have seals installed on their edges, in order to achieve better gas sealing, when sliding along the enclosure's inner walls and/or around the other turbine shaft. In a constructive variant, the engine enclosure could be in the form of a cylinder with two circular lids at each end (FIG. 1), while the blades would have a rectangular profile in longitudinal section (FIG. 2). However, in other constructive variants, the interior shape of the engine enclosure will match the turbine blades profile which can vary (for example for a blade with circular profile the interior of the enclosure would be part of a toroidal form).

The blade thickness and the shaft diameter are such designed that the two turbines can rotate inside the enclosure, around the longitudinal inner shaft and the enclosure's walls, partially independently (the asynchronous part of rotation), until two adjacent turbine blades (or specific guides on the turbine shafts) touch each other, so one turbine can engage the other one in rotation (the synchronous part of rotation). The asynchronous part of rotation allows the opposite chambers to expand or shrink in a desired compression ratio. The synchronous part of rotation allow the turbines to shift together to a determined position inside enclosure (11).

The engine enclosure has one or more intake holes in the starting intake area (11), in order to supply one or more combustion reactants in the intake chamber and one or more exhaust holes in the complete exhaust area (11), to let out resulting gases from the exhaust chamber. Manifolds could be attached to the enclosure, to direct both intake and exhaust flows. Usually, but not exclusively, the atmospheric air, containing oxygen, as one common reactant, would be supplied through the intake holes. The other reactant, usually but not exclusively, hydrocarbons contained in fuel, could be supplied within intake flow outside the engine enclosure, and/or injected inside the engine at one or more points, before and/or during the power stroke. For the purpose of starting the engine, compressed air or air/fuel mixture could be supplied before the power stroke through a valve. The ignition of combustion mixture could be either unaided or aided (usually, but not exclusively, by electric sparks from one or more spark plugs attached to engine enclosure in the power stroke area (11)).

Each chamber passes successively throughout all four strokes of the combustion cycle (intake, compression, power, and exhaust) during one turbine full revolution around the inner shaft. For example, when the chamber C1 is in the intake stroke, the chamber C2 is in the compression stroke, the chamber C3 is in the power stroke, and the chamber C4 is in the exhaust stroke.

The useful rotary mechanical energy results from the expansion of the high-temperature and high-pressure gases produced by combustion (the active stroke), that apply direct force to two adjacent turbine blades delimiting the combustion chamber. For example, in the FIG. 4 the turbines positions are considered to be the initial positions of the functional cycle and the power stroke will start in the chamber C3. The turbine T2 is kept static relative to engine enclosure (prevented to rotate counter wise, usually, but not exclusively, by a latch, ratchet, or freewheel type mechanism), while the other turbine (T1) rotate as much as allowed for the asynchronous part of rotation (3). This is the powered part of the cycle, providing energy for all other (passive) strokes happening in the other three chambers, as well a surplus to be used outside the engine. This surplus could be transmitted by coupling the shaft of the rotating turbine, during the active stroke, to the engine inner shaft and/or to a flywheel, and/or to a rotor of an electric generator, and/or to other appropriate collecting device. Usually, but not exclusively, the coupling above could be achieved using freewheel type mechanisms and/or latches powered mechanically or electromagnetically. Outside the exhaust hole, the eventual remnant energy from combustion, could be collected for further use (usually, but mot exclusively, through a turbine attached to the exhaust manifold).

At the end of the power stroke, both turbines shift, for the synchronous part of the rotation, so the turbine (T2) arrive in the position were the rotating turbine (T1) was when the power stroke started. As the residual momentum accumulated in the rotating turbine T1, might be insufficient for the synchronous shifting of both turbines, a proper external force will be applied to the turbine T1 for this period, most likely in a similar way, and as a part of the surplus resulted in the power stroke, after being stored properly (for example in a flywheel and/or in a electricity storage, as would be a battery, for an electromagnetic device).

After the shifting period ends, the turbine T1 is kept static relative to the engine enclosure similar as the turbine T2 before (6). In this way the blade B2 of turbine T1 have moved past the exhaust holes allowing the chamber C3 to communicate outside engine enclosure. Accordingly, the chamber enters the exhaust stroke, when resulting gases are pushed outside engine by the chamber remnant pressure combined with the push from blade B2 of turbine T2, which enters in active period (power stroke in chamber C2). Concomitantly, the chamber C1 enters in the compression stroke and the chamber C4 in the intake stroke.

At the end of power stroke in the chamber C2 both turbines shift again as mentioned above (7), then similar power strokes and shifting will happen sequentially for the chamber C1 and C4, while the other chambers will be in different strokes, depending on their position inside the engine. The engine continue to function this way until stopped, usually but not exclusively, by cutting the fuel supply. To start the engine the turbines are rotated until they arrive in the initial position described above (6), by applying an external force, usually, but not exclusively, using an electric motor.

The engine enclosure could be further encapsulated to allow lubricating and/or cooling fluids circulate inside the engine (outside the stroke chambers), along shafts and bores, in one or more separate circuits. Traces of lubricant might be allowed inside the stroke chambers, in order to reduce the friction between the turbine edges/seals and the enclosure walls. External walls of the engine enclosure could be profiled to allow better dissipation for heat. Bearings could be used to reduce the friction between rotary parts (usually shafts) and other surfaces (usually bores).

For the purpose of this description, rotating forward means clockwise. However, when seeing the engine from the opposite perspective, rotating forward would mean counterclockwise. In a schematic circular traversal section of the engine (FIG. 4), the following important points and arcs are noted in forward direction: —the arc AB, representing the maximum extent that a turbine can rotate until its blades get in contact with the other turbine blades, therefore, corresponding to the length of asynchronous part of turbines rotation,
the arc BC equal with length of arc AB divided by compression ratio minus one, corresponding to the length of the synchronous part of turbines rotation.
the arc DE equal with the arc AB,
the arcs CD, EF, and FA, are all equal with the arc BC,
the arc BC is by convention called the “complete compression area”,
the arc CD is by convention called the “starting ignition area”,
the arc EF is by convention called the “complete exhausting area”,
the arc FA is by convention called the “starting intake area”,
the arc FB is by convention called the “intake stroke area”,
the arc AC is by convention called the “compression stroke area”,
the arc CE is by convention called the “power stroke area”,
the arc DF is by convention called the “exhaust stroke area”,
points A and D corresponding to initial position for turbine T1,
points F and C corresponding to initial position for turbine T2,
points B and E corresponding to the position of a turbine at the end of its asynchronous rotation,

When the blade of a turbine moves from point A to B, the other blade moves simultaneously from point D to E, while the other turbine stays still between points C and F. Accordingly, the chamber ahead of the blade moving from A to B is in compression stroke, while the chamber behind the blade is in the intake stroke. The chamber ahead of the blade moving from D to E is in exhaust stroke, while the chamber behind the blade is in the power stroke. Ahead means the direction of turbine rotation. When the rotating turbine reaches the position between the point B and E, an external force is applied to it so its blades move from B to E and respectively from E to F. At the same time the other turbine blades move from C to D and respectively from F to A.

In another constructive variant of the engine, each of the two turbines has four blades attached at 90 degrees each other, so eight separate chambers will result inside enclosure, with eight strokes happening at the same time, two of each type. Each chamber will pass throughout the four-stroke cycle twice within a full revolution around the engine longitudinal axis. Accordingly, there will be two starting intake areas situated at 180 degrees each other. Similar doubling and positioning for the complete exhausting areas and eventually for fuel injectors and ignition devices. In other constructive variants of the engine, the two turbines could have any other equal number of blades, attached at an equal angle between them. However, if the number of blades on an turbine is odd, then the starting intake area in one cycle would overlap with the starting ignition area of next cycle and the complete exhausting area in one cycle would overlap with the complete compression area of the next cycle. In those cases of area overlapping, in order to maintain the functionality, the intake and exhaust holes must have valves, that will open only during the intake and exhaust strokes respectively.

What is claimed is:

1. A rotary internal combustion engine, comprised mainly of two turbines, each one consisting of a shaft with two blades, that interpenetrate, from the opposite directions of the same longitudinal axis, inside an enclosure with circular traversal section. Each turbine shaft have ends, extended outside the enclosure, to allow mechanical input to be applied to the turbine as well useful mechanical output to be collected. Any turbine blade extends from its own shaft to the enclosure's walls and to the other turbine shaft, in order for all four blades to create four separate dynamic chambers inside the enclosure. Each chamber passes successively throughout all four strokes of the combustion cycle (intake, compression, power, and exhaust) during one turbine full revolution around said axis. The engine enclosure has one or more intake holes as well exhaust holes. The combustion reactants are provided together completely or partially at the intake holes or separately, with one reactant, usually fuel, injected in one or more points during the intake and/or compression strokes. Both turbines rotate successively in the same direction, powered by the mechanical energy that results from the expansion of the high-temperature and high-pressure gases produced by combustion. The said energy applies direct force to two adjacent blades of the two turbines, delimiting the combustion chamber, however one of the turbine is prevented to rotate in the opposite direction by a proper device, while the other turbine rotates, providing energy for the strokes in the other three chambers and mechanical output, until said adjacent blade reaches the other blade of the opposite turbine. Then both turbines are shifted by applying an external force until getting in the position where resultant gases can be exhausted, and the adjacent chamber, previously in compression stroke, can start another combustion stroke.

2. The rotary internal combustion engine of claim 1, wherein said turbines rotate around an inner shaft, that can collect or apply torque from or to turbines.

3. The rotary internal combustion engine of claim 2, wherein the combustion is unaided or aided by igniters (as for example spark plugs).

4. The rotary internal combustion engine of claim 3, wherein each of the two turbines has four blades attached at 90 degrees each other, so eight separate chambers will result inside enclosure, with eight strokes happening at the same time, two of each type. Each chamber will pass throughout the four-stroke cycle twice within a full revolution around the engine longitudinal axis.
